(19) United States
(12) Patent Application Publication
(10) Pub. No.: US 2010/0046528 A1
(43) Pub. Date: Feb. 25, 2010

(54) Intelligent IMS Gateway for Legacy DSLAMs

(75) Inventor: George Foti, Dollard des Ormeaux (CA)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET LM ERICSSON (PUBL), Stockholm (SE)

(21) Appl. No.: 12/195,557

(22) Filed: Aug. 21, 2008

(51) Int. Cl. H04L 12/28

(52) U.S. Cl. 370/401

(57) ABSTRACT

Systems and methods according to the present invention address this need and others by improving service within the telecommunications field for gateways. According to exemplary embodiments, a gateway stores policy information which it uses to determine whether access to a requested service is permissible. The gateway manages a single Internet Multimedia Subsystem (IMS) session capable of supporting multiple requests for service from different requesting sources.

### TECHNICAL FIELD

The present invention relates generally to telecommunications systems and improving service therein.

### BACKGROUND

As the level of technology increases, the options for communications have become more varied. For example, in the last 30 years in the telecommunications industry, personal communications have evolved from a home having a single rotary dial telephone, to a home having multiple telephone, cable and/or fiber optic lines that accommodate both voice and data. Additionally, cellular phones and Wi-Fi have added a mobile element to communications. Similarly, in the entertainment industry, 30 years ago there was only one format for television and this format was transmitted over the air and received via antennas located at homes. This has evolved into both different standards of picture quality such as, standard definition TV (SDTV), enhanced definition TV (EDTV) and high definition TV (HDTV), and more systems for delivery of these different television display formats such as cable and satellite. Additionally, services have grown to become overlapping between these two industries. As these systems continue to evolve in both industries, the service offerings will continue to merge and new services can be expected to be available for a consumer. Also these services will be based on the technical capability to process and output more information, for example as seen in the improvements in the picture quality of programs viewed on televisions, and therefore it is expected that service delivery requirements will continue to rely on more bandwidth being available throughout the network including the “last mile” to the end user.

Another related technology that impacts both the communications and entertainment industries is the Internet. The physical structures of the Internet and associated communication streams have also evolved to handle an increased flow of data. Servers have more memory than ever before, communications links exist that have a higher bandwidth than in the past, processors are faster and more capable and protocols exist to take advantage of these elements. As consumers' usage of the Internet grows, service companies have turned to the Internet (and other Internet Protocol (IP) networks) as a mechanism for providing traditional services. These multimedia services include IP television (IPTV, referring to systems or services that deliver television programs over a network using IP data packets), video on demand (VOD), voice over IP (VoIP), and other web related services received singly or bundled together. In IPTV, an ITF (IPTV Terminal Function) provides the end-user with the actual IPTV service.

To accommodate the new and different ways in which IP networks are being used to provide various services, new network architectures are being developed and standardized. Internet Multimedia Subsystem (IMS) is an architectural framework utilized for delivering IP multimedia services to an end user. The IMS architecture has evolved into a service-independent topology which uses IP protocols, e.g., Session Initiation Protocol (SIP) signaling, to provide a convergence mechanism for disparate systems. In part this is accomplished via the provision of a horizontal control layer which isolates the access network from the service layer. Among other things, IMS architectures may provide a useful platform for the rollout of IPTV systems and services.

The current solution in TISAPN (Telecommunications and Internet Protocol Harmonization over Networks) and SPAN (Services and Protocols for Advanced Networks) assumes that an IMS session is needed for each ITF in a household. This solution also assumes that user access policies negotiated during the IMS session setup have to be downloaded in DSLAMs (digital subscriber line access multiplexer) closer to the end-user for enforcement. These policies govern the bandwidth allocated for watching linear television and white list channels (list of channels that can be watched) allowed for the ITF.

However, the current TISPAN solution poses some challenges. First, there exists a scalability issue regarding the large number of IMS sessions required to support the IPTV service, because there is a necessity today to use one IMS session for each ITF. In some cases, of e.g. a power outage when sessions are lost, a re-establishment of the IMS sessions results in a huge traffic surge when all ITFs come back online at the same time. This can disrupt traffic and negatively affect the flow control needed both for IMS registration and IMS sessions. Furthermore, there is a large number of existing DSLAMs that are not configured to accept and enforce user policies. Hence, the current solution only works for new DSLAMs.

Accordingly exemplary systems and methods for improving service are described below.

### SUMMARY

Systems and methods according to exemplary embodiments can improve service within the telecommunications field.

According to one exemplary embodiment a gateway includes: an interface for receiving a first request for a service via control plane signaling; a memory device for storing policy information; and a processor for executing an Internet Group Management Protocol (IGMP) proxy function the IGMP proxy function performing IGMP hosting functions and determining whether access to the requested service is permissible based on the stored policy information, wherein the processor also manages a single Internet Multimedia Subsystem (IMS) session capable of supporting multiple requests for service from different requesting services.

According to another exemplary embodiment a method for communicating by a gateway includes: receiving a first request for a service via control plane signaling at an interface; storing policy information on a memory device; performing Internet Group Management Protocol (IGMP) hosting functions by executing an IGMP proxy function by a processor; determining whether access to the requested service is permissible based on the stored policy function; and managing a single Internet Multimedia Subsystem (IMS) session capable of supporting multiple requests for service from different requesting sources.

A computer-readable medium containing program instructions which, when executed by a computer or a processor, perform the steps of: receiving a first request for a service via control plane signaling at an interface; storing policy information on a memory device; performing Internet Group Management Protocol (IGMP) hosting functions by executing an IGMP proxy function on a processor; determining whether access to the requested service is permissible based on the stored policy information; and managing a single Internet Multimedia Subsystem (IMS) session capable of supporting multiple requests for service from different requesting sources.

### BRIEF DESCRIPTION OF THE DRAWINGS

The accompanying drawings illustrate exemplary embodiments, wherein:

FIG. 1 shows a communications diagram from a household to an Internet Multimedia Subsystem (IMS) network;

FIG. 2 depicts a communications diagram from a household to an Internet Multimedia Subsystem (IMS) network according to exemplary embodiments;

FIG. 3 illustrates communications within a household according to exemplary embodiments;

FIG. 4 shows communications on the Wide Area Network (WAN) side according to exemplary embodiments;

FIG. 5 depicts an IMS registration for an IMS/Internet Protocol Television (IPTV) gateway/router according to exemplary embodiments;

FIG. 6 depicts IMS registration for two IPTV Terminal Functions (ITFs) according to exemplary embodiments;

FIG. 7 shows an allowed and a denied traffic scenario according to exemplary embodiments;

FIG. 8 shows a communication node according to exemplary embodiments; and

FIG. 9 shows a method flowchart according to exemplary embodiments.

### DETAILED DESCRIPTION

The following detailed description of the exemplary embodiments refers to the accompanying drawings. The same reference numbers in different drawings identify the same or similar elements. Also, the following detailed description does not limit the invention. Instead, the scope of the invention is defined by the appended claims.

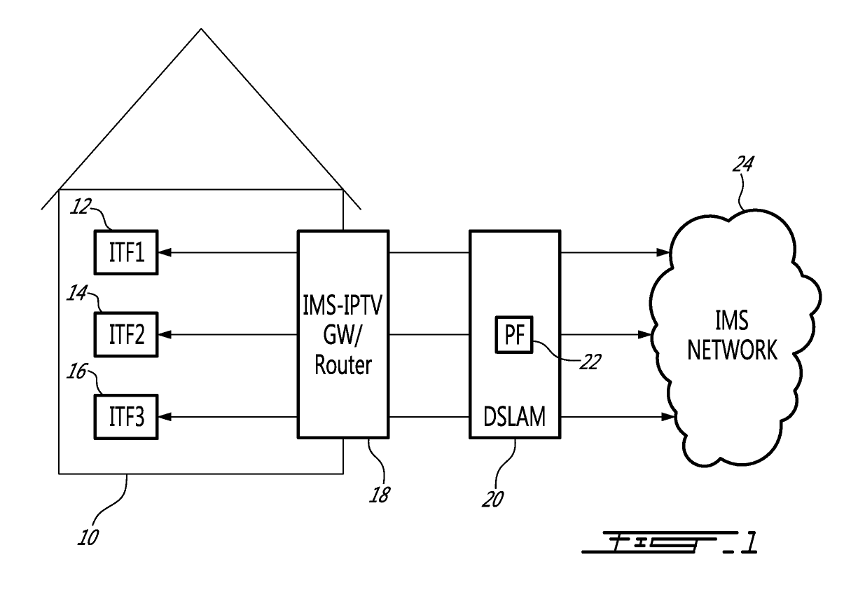

Systems and methods according to exemplary embodiments can improve service within the telecommunications field. In order to provide context for this discussion, an exemplary grouping of devices and communication links will now be described with respect to FIG. 1.

FIG. 1 shows a household 10, which includes three Internet Protocol Television Terminal Functions (ITFs) 12, 14 and 16, e.g., a device capable of receiving and displaying Internet Protocol Television programs (IPTV), in communications with an Internet Multimedia Subsystem/Internet Protocol Television (IMS/IPTV) gateway/router 18. While the gateway/router 18 is shown as a single device located in the home domain, it could also be two separate devices, e.g., a gateway portion and a router portion both of which are located in the home domain, in communications with each other, with the control signaling typically passing through (and selectively processed by) the gateway function portion and media signaling typically passing through (and selectively processed by) the router function portion. Additionally, a digital subscriber line access multiplexer (DSLAM) 20 with a policy function (PF) 22 is shown connecting the devices within household 10 to an IMS network 24. In this example, each ITF 12, 14 and 16, when connecting to the IMS network 24, has its own IMS session for linear TV purposes, i.e., when using Telecommunications and Internet Converged Services and Protocols for Advanced Networks (TISPAN) a separate IMS session is needed for each ITF 12, 14 and 16 operating within a single household 10. Policies are typically negotiated during the IMS session setups for each ITF 12, 14 and 16 and stored in a policy function 22 within DSLAM 20. Such policies include, for example, access policies which determine whether a corresponding user or ITF can access a particular channel or media program. Upon completion of the IMS session setup, users can start accessing the authorized linear TV channels. When the policy function 22 is within the DSLAM 20, policy enforcement for authorized channels occurs in the media plane. Additionally, while single lines denoting communications are shown going to and from each ITF 12, 14 and 16, typically, control plane signaling, e.g., policy information from policy function 22, passes through the gateway portion of IMS/IPTV gateway/router 18, while media plane signaling, e.g., media and associated Internet Group Management Protocol (IGMP) signaling, passes through the router portion of IMS/IPTV gateway/router 18.

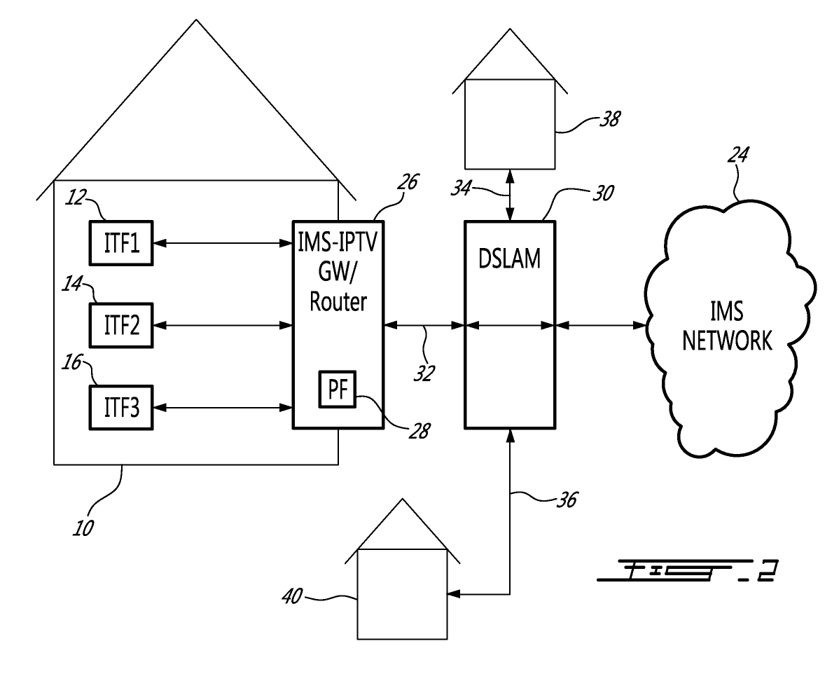

As shown in FIG. 1, the IMS/IPTV gateway/router 18 is depicted as being between the ITFs 12, 14 and 16 and the DSLAM 20, and can typically be considered to connect a local area network (LAN), e.g., the network of household 10, to a wide area network (WAN), e.g., IMS network 24 or another operator network. A DSLAM 20 will typically have multiple incoming physical DSLs 32, 34 and 36 (seen in FIG. 2), each of which connects the DSLAM 20 to a different individual household 10, 38 and 40, respectively. In the upstream direction, e.g., from the household 10 towards the IMS network 24, a DSLAM 20 will take the received signal and split the data and voice portions to be forwarded to the appropriate carrier network (not shown) or voice switch (not shown), respectively. Additionally, DSLAM 20 contains multiple modems and is located either in a central office or in a remote location to service an area, e.g., a neighborhood. The usage of IMS session and policy enforcement in DSLAM 20, allows for dynamic updates of policies, through session modification, and dynamic updates of renegotiated policies in the DSLAM 20 for enforcement.

However, the flexibility offered by IMS cannot be fully exploited with some currently deployed DSLAMs, e.g., some older versions of DSLAM 20, since they cannot handle dynamic update of policies. Accordingly, exemplary systems and methods for utilizing IMS with currently deployed DSLAMs enable the benefits of IMS to be fully exploited while not requiring immediate upgrades of existing DSLAMs that cannot handle dynamic update(s) of policies with an IMS defined scheme as will be described below.

According to exemplary embodiments, an IMS/IPTV gateway/router 26 can include a policy function 28 as shown in FIG. 2. Upon power up of an ITF 12, the IMS/IPTV gateway router 26 becomes aware of that ITF's active state. Consequently, the IMS/IPTV gateway/router 26 communicates through DSLAM 30, which typically does not have a policy function or the ability to dynamically update policies, to the IMS network 24 and performs IMS registration for the default household identity. Every household is assigned a default identity which is the registered identity, at power up, in the absence of any logged in IPTV end-user, e.g., a member of the household 10 on the ITF. The services allocated to the default identity are typically a subset of those allocated to a specific user.

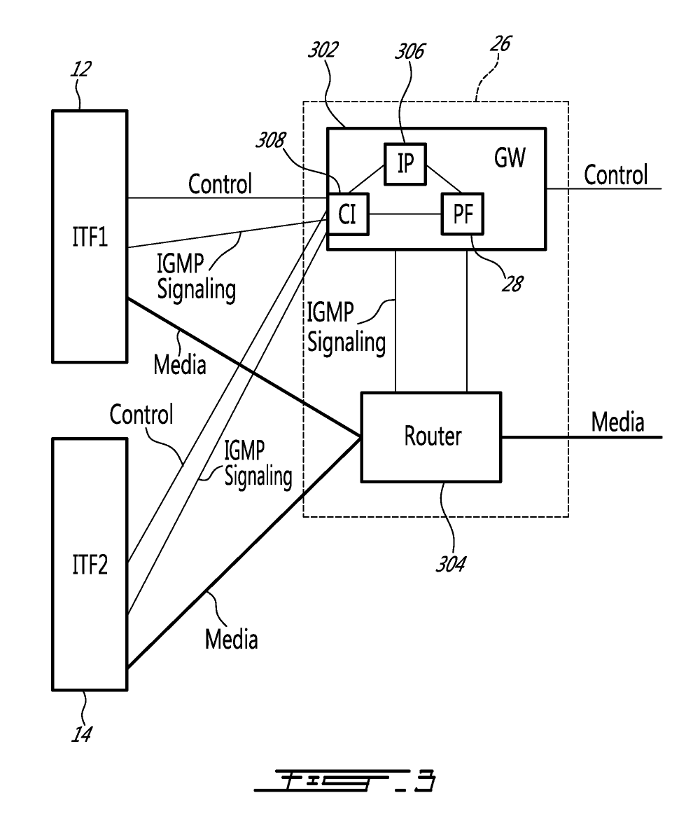

Following a successful IMS registration, the IMS/IPTV gateway/router 26 initiates a single IMS session for linear TV purpose for the entire household. Policy information negotiated during the IMS session setup can be received and stored in a memory (not shown in FIG. 2) associated with policy function 28 within gateway/router 26. On the user side, e.g., communications within household 10 to IMS/IPTV gateway/router 26, when each, some or all of the ITFs 12, 14 and 16 power up they communicate with the gateway/router 26, typically using IGMP signaling for linear TV purposes. Additional communications and signaling can occur between the ITFs 12, 14 and 16 and the IMS/IPTV gateway/router 26, e.g., for users logging in to the ITFs 12, 14 and 16, as well as when the IMS/IPTV gateway/router 26 performs IMS registration on behalf of the user. In this exemplary embodiment, the DSLAM 30 is not typically involved in policy enforcement. Also, it will be appreciated by those skilled in the art that while three ITFs 12, 14 and 16 are shown in FIG. 2, more or fewer ITFs can exist in an exemplary household 10. More specifics regarding these exemplary communications on the user side will be described below with respect to FIG. 3.

FIG. 3 shows an IMS-IPTV gateway/router 26 according to an exemplary embodiment that is in communication with ITF1 12 and ITF 2 14. IMS-IPTV gateway/router 26 includes a gateway function 302 and a router function 304 which receive and transmit control plane and media plane signals, respectively. Control plane functions (also sometimes referred to as the “signaling plane”) include, for example, routing call signaling, informing the transport level which traffic to allow and generating billing information, etc. Media plane functions (also sometimes referred to as the “user plane”) include access to the core network for user equipment to receive service payload data, e.g., IPTV programs or channels. Gateway function 302 includes an IGMP proxy function 306, a policy function 28 and a control plane signaling interface 308. Policy function 28 receives and stores policies for users. These policies typically dictate what services a user is authorized to access. The IGMP proxy function 306 performs IGMP hosting duties, e.g., controlling the forwarding of multicast traffic. Together the IGMP proxy function 306 and the policy function 28 enforce the stored policies by allowing or denying requests from the ITFs 12 and 14 using IGMP messaging over the control plane. These IGMP messages over the control plane are both, from the IMS/IPTV gateway/router's 26 point of view, received and transmitted using the control plane signaling interface 308. Additionally, this information, as needed, is transmitted to the router function 304 to ensure that only authorized services, e.g., authorized IPTV channel(s), are delivered over the media plane to the ITF(s) 12 and 14.

In addition to policy enforcement, control plane signaling performed by IMS/IPTV gateway/router 26 includes, among other things, IMS registration of IPTV end-users when they log in on the ITF(s) 12 and 14, fetching user policies when they successfully register in the IMS network, the initiation and management of the IMS session for linear TV, etc. According to exemplary embodiments, the IMS-IPTV gateway/router 26 is able to use only a single IMS session for the entire household which supports multiple ITFs associated with different users which are also registered with the IMS network 24. This can reduce the number of IMS sessions associated with a single household 10 from one IMS session per active ITF 12, 14 or 16 down to a single IMS session associated with the IMS/IPTV gateway/router 26 for all active ITFs 12, 14 and 16 in the household. Reducing the number of IMS sessions will reduce the signaling overhead, e.g., associated with system resets upon power failures or the like. In order to enforce user policies, the IMS/IPTV gateway/router 26 combines the policies established and stored during the IMS session setup, and which apply to all members of the household, with the user specific policies fetched during the user registration. This enables the use of a single IMS session for linear TV for all members of the household, while still applying individual user policies when those household users log in on a specific ITF and applying default policies to ITFs where no users are logged in.

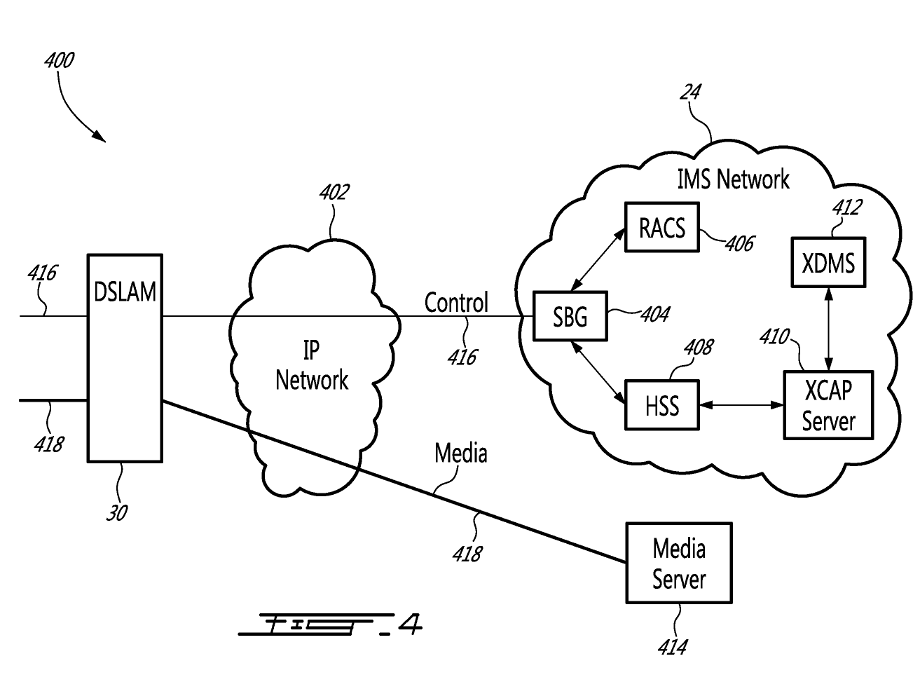

As described above, policies for both a household and specific users are received and stored by policy function 28. These policies are typically sent by nodes associated with an exemplary IMS network 24. Elements of an exemplary wide area network (WAN) side 400 including an IMS network 24 will now be described with respect to FIG. 4. The WAN side 400 includes DSLAM 30, an IP network 402, IMS network 24 and a media server 414. An exemplary IMS network 24 includes a session border gateway (SBG) 404, a resource and admission control subsystem (RACS) 406, a home subscriber server (HSS) 408, an eXtensible markup language (XML) configuration access protocol (XCAP) server 410 and an XML data management server (XDMS) 412. The SBG 404 represents a node where communications, typically control plane signaling, enter and leave the IMS network 24 for transmission through IP network 402 to DSLAM 30 to be forwarded to the appropriate IMS/IPTV gateway/router 26. The RACS 406 includes functional elements which are used to support policy based transport and control services including, admission control, policy authorization and network policy assembly.

The HSS 408 is a central repository or central access point for subscriber information which, for example, is used to establish IMS sessions and to provide services to subscribers. The XCAP server 410 communicates with the HSS 408 for authorization to access policy information, e.g., subscriber information including a whitelist and/or a blacklist, stored in XDMS 412. This policy information is also, as needed, sent from the XCAP server 410 to the policy function 28 within IMS/IPTV gateway/router 26 via control plane signaling 416. An IMS network will typically have more nodes/functions than those shown with respect to FIG. 4, however, for simplicity, only certain nodes have been shown. More information generally regarding IMS networks can be found in the Third Generation Partnership Project (3GPP) Technical Specification (TS) 23.228 Version 8 dated March 2007.

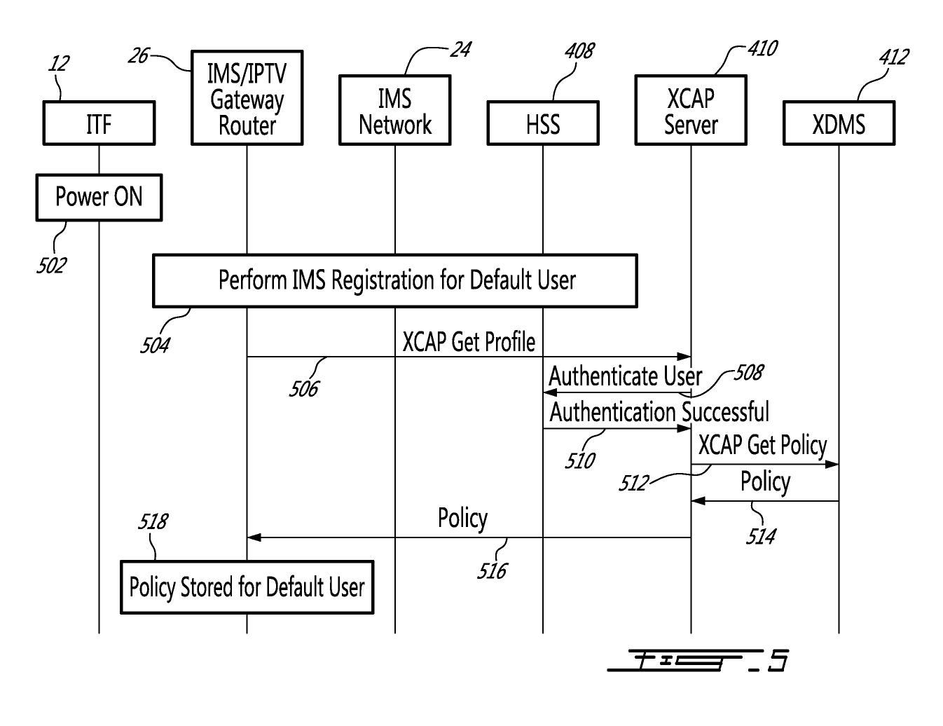

Media server 414 is also located on the WAN side 400 according to exemplary embodiments and can transmit media and/or services, over the media plane 418 to the router function 304 within IMS/IPTV gateway/router 26. Using the above described exemplary architectures and signaling paths shown in FIGS. 3 and 4, an exemplary signaling diagram for establishing an IMS session and an IMS registration for the IMS/IPTV gateway/router 26 is shown in FIG. 5 and will be described below.

Initially in FIG. 5, the first ITF 12 in the household is powered up in step 502. After completing power up in step 502, the IMS/IPTV gateway/router 26 performs IMS registration for a default user with the HSS 408 in IMS network 24 in step 504 and, following a successful registration, initiates an IMS session for linear TV (step not shown in FIG. 5) after acquiring the default user profile. The linear TV session allows ITF 12 to view normal TV immediately at power up. The default user identity is a default identity allocated to every household and allows users to watch TV immediately at power up without the need to explicitly login. This gives users the same feel and look for IPTV as legacy TV. Upon completion of the IMS registration, the IMS/IPTV gateway/router 26 then requests policy information from the XCAP server 410 in message 506. The XCAP server 410 then transmits message 508 to the HSS 408 for authenticating the default user identity. The authentication validation response, e.g., authentication successful, is returned to the XCAP server 410 from the HSS 408 in message 510. Upon receipt of a successful authentication, the XCAP server 410 transmits a message 512 to the XDMS 412 requesting the default user identity policy. The XDMS 412 transmits the requested default user policy in message 514, which is then sent from the XCAP server 410 back to the IMS/IPTV gateway/router 26 in message 516. The default user policy is then stored by the policy function 28 within the IMS/IPTV gateway/router 26 in step 518.

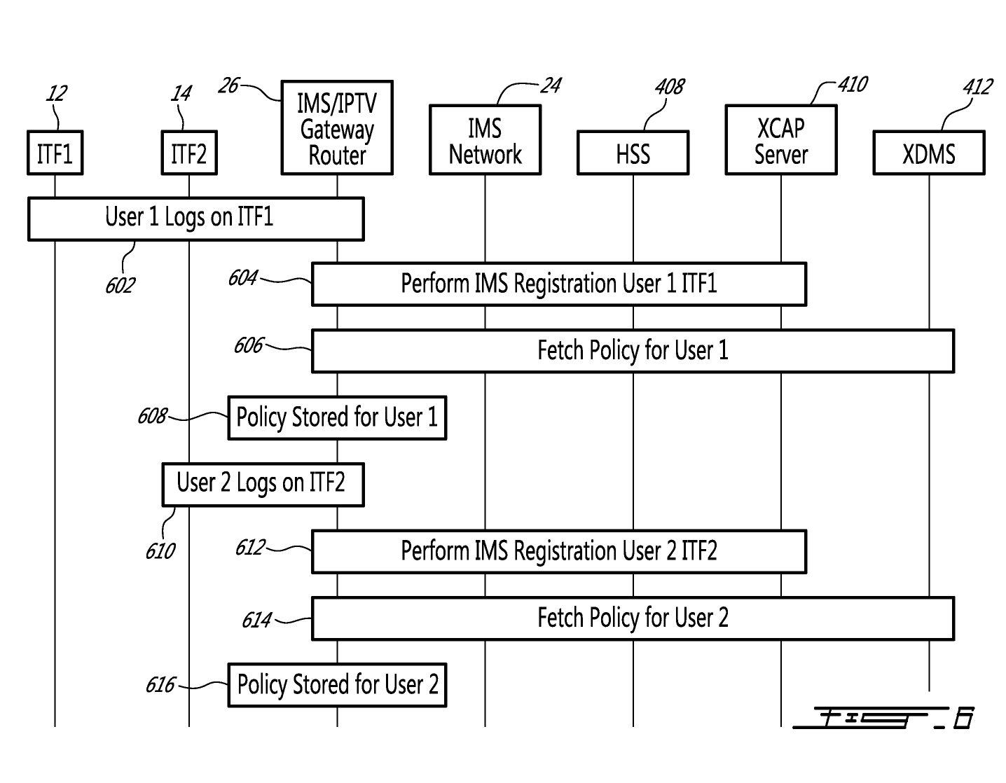

The same procedure is performed when other ITFs (14 or 16) are powered on in the household. If a user in the household wishes their own policies and services to take effect and execute, then the user must first login locally on an ITF (12, 14 or 16). The ITF (12, 14 or 16) then instructs the IMS/IPTV gateway/router 26 to login in the user in the IMS network 24 as illustrated in FIG. 6. Initially, user1 uses ITF1 12 and logs on with the IMS/IPTV gateway/router 26 in step 602. In step 604, the IMS/IPTV gateway/router 26 performs IMS registration for user1 on ITF1 12 with the IMS network 24 using the existing IMS session. This is typically performed using the same nodes and messages as described above for the IMS/IPTV gateway/router 26 and as shown in FIG. 5. In step 606, the policy for user1 is requested and received by IMS/IPTV gateway/router 26. The policy for user1 is then stored by the policy function 28 in step 608. A similar process can also be performed for user2 using ITF2 14. The IMS/IPTV gateway/router 26 can then apply the initial policies received and stored during the IMS session set up procedure in addition to those policies fetched for the specific registered user to enforce the user specific policies.

For example, as also shown in FIG. 6, user2 logs on ITF2 14 with the IMS/IPTV gateway/router 26. In step 612, the IMS/IPTV gateway/router 26 performs IMS registration for user2 on ITF2 with the IMS network 24 typically using the same nodes and messages as described above for the IMS/IPTV gateway/router 26 in and as shown in FIG. 5. In step 614 policy information for user2 is requested and received by IMS/IPTV gateway/router 26. Policy information for user2 is then stored by the policy function 28 in step 616. In each case, i.e., the IMS registration for user1 and user2, policy information is only received if authentication successfully occurs. In cases where authentication fails, users will still be able to access whatever services are allowed under the policy information previously stored associated with the default identity.

Additionally, according to exemplary embodiments, the IMS/IPTV gateway/router 26 is fully stateful in regard to powered on ITFs 12, 14 and 16 as well as logged in users including the association between the users and the ITFs 12, 14 and 16. In other words, the IMS/IPTV gateway/router 26 is aware which ITF 12, 14 and 16 is powered on, the user that is logged on for the ITF 12, 14 and 16, as well as the policies associated with a specific user. Also, the IMS/IPTV gateway/router 26 maintains such a state in its memory as long as the user is logged on and the ITF 12, 14 and 16 is powered on.

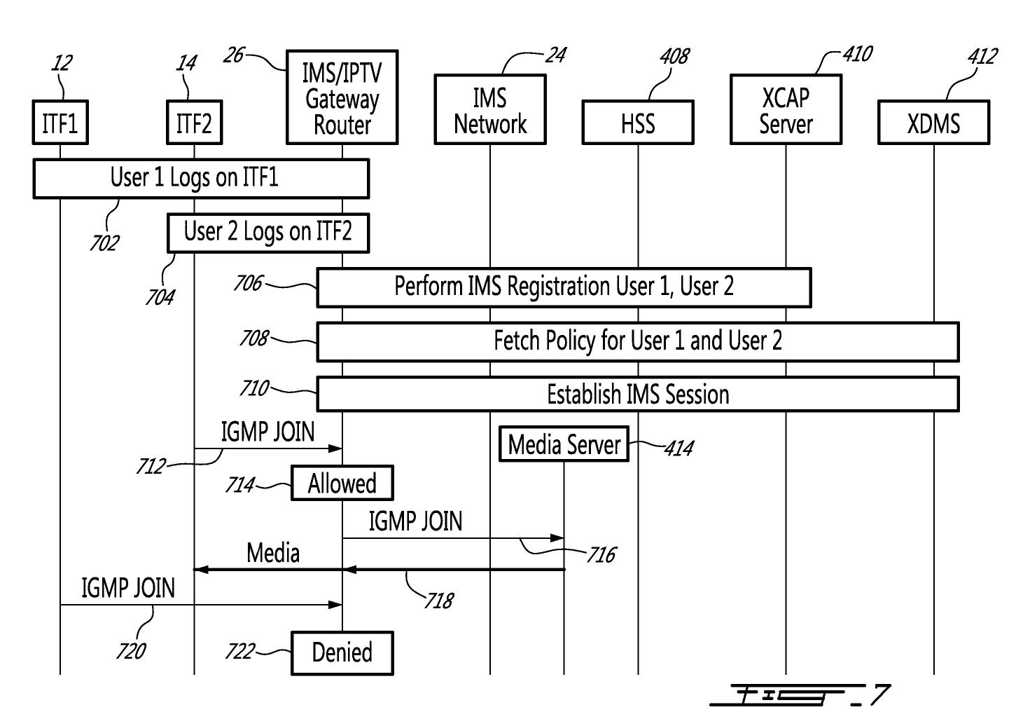

According to exemplary embodiments, FIG. 7 shows an example of two different ITFs 12 and 14 located in the same household 10, and performing IMS registration, with ITF1 12 being denied access to a requested program, and with ITF2 14 gaining access to a requested program. Initially user1 logs on ITF1 in step 702 and user2 logs on ITF2 in step 704. In step 706, the IMS/IPTV gateway/router 26 performs the IMS registration for user1 and user2. The policies are fetched for user1 and user2 in step 708. The IMS/IPTV gateway/router 26 then establishes an IMS session in step 710 for the default household user, i.e., establishing an IMS session for the IMS/IPTV gateway/router 26 and not establishing IMS sessions for each of user1 and user2 (the IMS registration of the default household user and the fetching of the associated policies have been removed for brevity from FIG. 7). The IMS/IPTV gateway/router 26 then combines the policies stored during session initiation with each later obtained and stored user policy for use in policy enforcement. An IGMP JOIN message 712 requesting, for example, a channel and a program, is then sent from ITF2 14 to IMS/IPTV gateway/router 26 which determines whether or not, based on stored policy information, user2 is authorized to watch the requested programming. In this example, as shown in step 714, the IMS/IPTV gateway/router 26 is allowing the request. The IGMP JOIN message 716 is then sent to the media server 414 which in turns sends the requested channel and program 718 back to the IMS/IPTV gateway/router 26 over the media plane which forwards the requested channel and program to ITF2 14. An IGMP JOIN message 720 is sent from ITF1 12 to IMS/IPTV gateway/router 26 also requesting a channel and a program. However, in this case, based on stored policy information, the IMS/IPTV gateway/router 26 denies the request in step 722.

According to another exemplary embodiment, IMS/IPTV gateway/router 26 controls and makes bandwidth requests for all ITFs 12, 14 and 16 in household 10. Additionally, IMS/IPTV gateway/router 26 can proactively request authorization for more bandwidth in the last mile as more ITFs are powered on or as the viewing habits of users change, i.e., the IMS/IPTV gateway/router 26 is capable, as well, of learning and adapting to a user's viewing habits. This capability is a result of the usage of XCAP for fetching users' policy information according to exemplary embodiments. For example, IMS/IPTV gateway/router 26 uses the SIP SUBSCRIBE/NOTOFY framework, defined in RFC 3265, with the xcap-diff event package, and which is supported by XCAP server 410 to be notified about any changes in users policies. This allows the IMS/IPTV gateway/router 26 to be notified, e.g., in real-time, about any changes and thus can apply them immediately, i.e., apply changes dynamically. Hence any session modification requests triggered by a user on an ITF 12, 14 or 16 for viewing channels that require additional bandwidth than currently authorized, can be verified by the IMS/IPTV gateway/router 26 before it initiates the corresponding IMS session modification request to the IMS network 24.

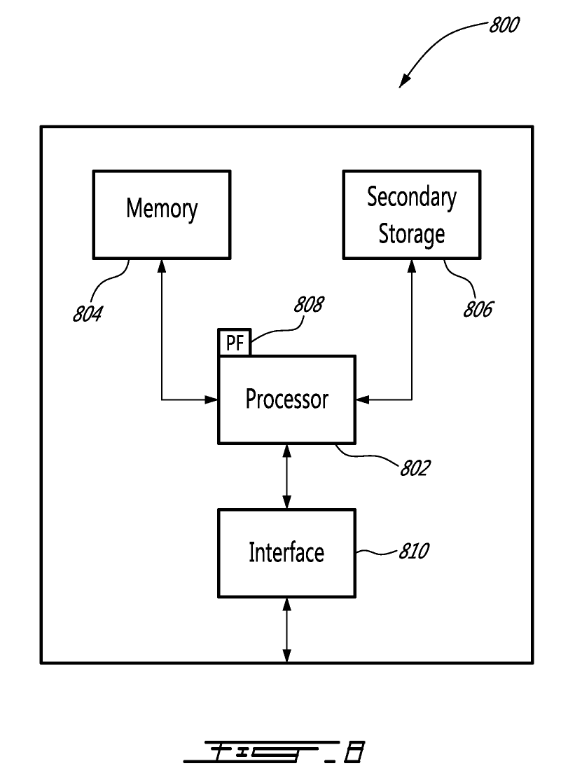

The exemplary embodiments described above provide for an IGMP proxy function 28 within an IMS/IPTV gateway/router 26. An exemplary communications node 800 which can be used, for example, to implement IMS/IPTV gateway/router 26 described above, will now be described with respect to FIG. 8. Gateway 800 (or node) can contain a processor 802 (or multiple processor cores), memory 804, one or more secondary storage devices 806, a policy function 808 and an interface unit 810 to facilitate communications between gateway 800 and the rest of the network. Processor 802 can also function as an IGMP proxy function as described above. Also a policy function 808 can be associated with processor 802 for determining whether to grant access to media requests based on policy and policy information stored within either the policy function 808, memory 804 or the secondary storage 806. Additionally, gateway 800 is capable of creating an IMS session to support multiple ITFs which have an IMS registration and wish to access media and/or services, e.g., IPTV channels and programs. The additional function of a router can also be provided part of gateway 800.

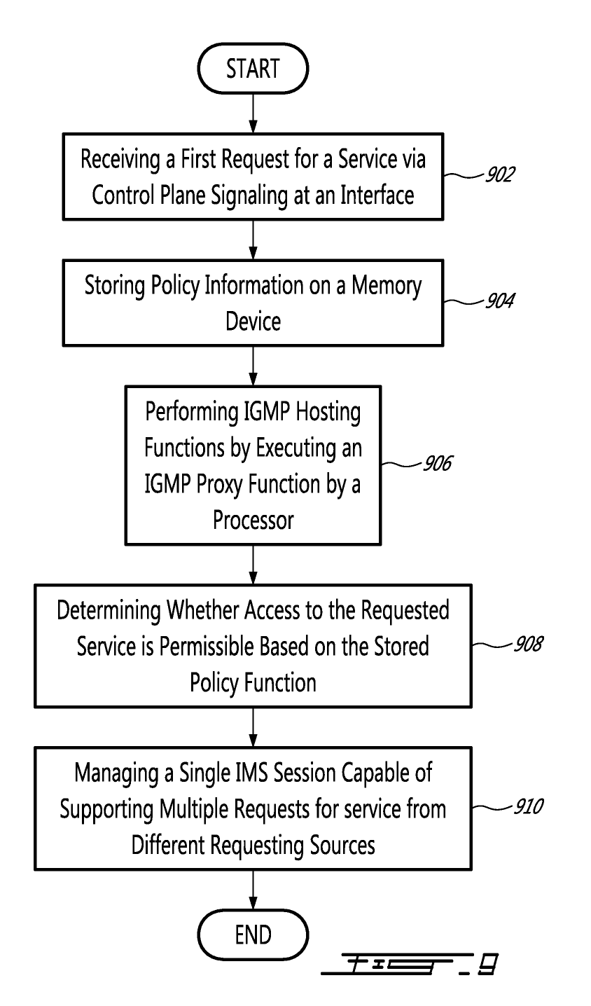

Utilizing the above-described exemplary systems according to exemplary embodiments, a method for communicating by a gateway is shown in the flowchart of FIG. 9. Initially a method for communicating by a gateway includes: receiving a first request for a service via control plane signaling at an interface in step 902; storing policy information on a memory device in step 904; performing Internet Group Management Protocol (IGMP) hosting functions by executing an IGMP proxy function by a processor in step 906; determining whether access to the requested service is permissible based on the stored policy function in step 908; and managing a single Internet Multimedia Subsystem (IMS) session capable of supporting multiple requests for service from different requesting sources in step 910.

As will be appreciated by those skilled in the art, methods such as that illustrated in FIG. 9 can be implemented completely or partially in software. Thus, systems and methods for processing data according to exemplary embodiments of the present invention can be performed by one or more processors executing sequences of instructions contained in a memory device. Such instructions may be read into the memory device 804 from other computer-readable mediums such as secondary data storage device(s) 806, which may be fixed, removable or remote (network storage) media. Execution of the sequences of instructions contained in the memory device causes the processor to operate, for example, as described above. In alternative embodiments, hard-wire circuitry may be used in place of or in combination with software instructions to implement exemplary embodiments.

The above-described exemplary embodiments are intended to be illustrative in all respects, rather than restrictive, of the present invention. All such variations and modifications are considered to be within the scope and spirit of the present invention as defined by the following claims. For example, an IMS network 24 will typically include more nodes but for simplicity only certain nodes have been shown. Additionally, IMS-IPTV gateway/router 26 can be a single device or two separate devices. No element, act, or instruction used in the description of the present application should be construed as critical or essential to the invention unless explicitly described as such. Also, as used herein, the article “a” is intended to include one or more items.

1. A gateway comprising:
an interface for receiving a first request for a service via control plane signaling;
a memory device for storing policy information; and
a processor for executing an Internet Group Management Protocol (IGMP) proxy function said IGMP proxy function performing IGMP hosting functions and determining whether access to said requested service is permissible based on said stored policy information, wherein said processor also manages a single Internet Multimedia Subsystem (IMS) session capable of supporting multiple requests for service from different requesting sources.

2. The gateway of claim 1, wherein said interface receives a second request for service via control plane signaling from a source which is different from another source which issued said first request.

3. The gateway of claim 1, wherein said stored policy information includes a default user policy information obtained during an IMS session setup and a specific user policy information.

4. The gateway of claim 3, wherein said specific user policy is obtained from an eXtensible markup language data management server (XDMS).

5. The gateway of claim 1, wherein said processor is also for making bandwidth requests associated with expected future requests.

6. The gateway of claim 1, further comprising:
a router for delivering said service using media plane signaling.

7. The gateway of claim 1, wherein said gateway connects a local area network (LAN) to a wide area network (WAN).

8. The gateway of claim 7, wherein said gateway is connected to a digital subscriber line access multiplexer (DSLAM), and further wherein said DSLAM is a part of said WAN.

9. The gateway of claim 8, wherein said stored policy information is dynamically updated and restored.

10. The gateway of claim 9, wherein said stored policy information is at least one of a whitelist and a blacklist.

11. The gateway of claim 1, wherein said request for service is originated by an Internet Protocol Television Terminal Function (ITF) and includes a request for one of a channel and a program.

12. A method for communicating by a gateway comprising:
receiving a first request for a service via control plane signaling at an interface;
storing policy information on a memory device;
performing Internet Group Management Protocol (IGMP) hosting functions by executing an IGMP proxy function on a processor;
determining whether access to said requested service is permissible based on said stored policy information; and
managing a single Internet Multimedia Subsystem (IMS) session capable of supporting multiple requests for service from different requesting sources.

13. The method of claim 12, further comprising:
receiving, by said interface, a second request for service via control plane signaling from a source which is different from another source which issued said first request.

14. The method of claim 12, wherein said stored policy information includes a default user policy information obtained during an IMS session setup and a specific user policy information.

15. The method of claim 14, wherein said specific user policy is obtained from an eXtensible markup language data management server (XDMS).

16. The method of claim 12, further comprising:
making bandwidth requests associated with expected future requests by said processor.

17. The method of claim 12, further comprising:
delivering said service using media plane signaling by a router.

18. The method of claim 12, wherein said gateway connects a local area network (LAN) to a wide area network (WAN).

19. The method of claim 18, wherein said gateway is connected to a digital subscriber line access multiplexer (DSLAM), and further wherein said DSLAM is a part of said WAN.

20. The method of claim 12, further comprising:
dynamically updating and restoring said stored policy information.

21. The method of claim 12, wherein said stored policy information is at least one of a whitelist and a blacklist.

22. The method of claim 12, wherein said request for service is originated by an Internet Protocol Television Terminal Function (ITF) and includes a request for one of a channel and a program.

23. A computer-readable medium containing program instructions which, when executed by a computer or a processor, perform the steps of:
receiving a first request for a service via control plane signaling at an interface;
storing policy information on a memory device;
performing Internet Group Management Protocol (IGMP) hosting functions by executing an IGMP proxy function on a processor;
determining whether access to said requested service is permissible based on said stored policy information; and
managing a single Internet Multimedia Subsystem (IMS) session capable of supporting multiple requests for service from different requesting sources.
